(19) United States
(12) Patent Application Publication
(10) Pub. No.: US 2016/0361895 A1
(43) Pub. Date: Dec. 15, 2016

(54) PLANAR SUPPORT WITH TWO FACES FOR WRITING OR DRAWING BY HAND

(71) Applicant: CANSON, Herouville-Saint-Clair (FR)

(72) Inventor: Philippe Noblet-Reverbel, Vienne (FR)

(21) Appl. No.: 15/168,478

(22) Filed: May 31, 2016

(30) Foreign Application Priority Data
Jun. 9, 2015 (FR) 15 55 251
Mar. 1, 2016 (FR) 16 51 696

(51) Int. Cl. B32B 5/22; B32B 27/36; B32B 27/32; B32B 37/14

(52) U.S. Cl. CPC B32B 5/22; B32B 37/14; B32B 27/36; B32B 27/32; B32B 2307/41

(57) ABSTRACT

A planar support with two faces for drawing on the two faces of a graphic design, by hand, consists of two fibrous layers having the two faces, a film inside the support making the support opaque, and thermoplastic material layers adhering each of the fibrous sheets, wherein the thermoplastic material layers include light-colored fillers concealing the film

### TECHNICAL BACKGROUND

The present invention relates to a planar support with two faces for graphic design (writing or drawing) done by hand, as well as a sheet cut from said support, optionally proposed in the form of reams, pads, notebooks or books of sheets. The invention also pertains to the method for manufacturing the planar support.

The planar support according to the invention is particularly suited for graphic design with felt markers, for example graphic illustration (drawing) with felt markers, or writing with felt markers. The marker may be a solvent-based marker (permanent) or a water-based marker.

Drawing with markers is done by illustrators for boards developed in one copy by hand. Such boards may next be sold or kept in the form of single copies, or may also next be scanned to undergo mass production.

Traditionally, the planar supports for graphic design done by hand are paper or paper-based supports. Paper is a material whereof the majority is made up of fibers, cellulose or synthetic, mixed with various additives making it possible to contribute certain properties to the material or to reinforce them, depending on the anticipated ultimate use of the product. The available products are relatively thin, with grammages for example of approximately 60 to 260 g/m².

Users appreciate when the planar support of the paper type is usable on both sides. Nevertheless, in the case of the use of such a support for graphic design using markers, whether the latter are solvent- or water-based, the problem arises of the pigments leaking through the sheet, the material of which is porous.

Furthermore, even when the pigments do not cross through, the shadow from the graphic marks made on one face may be visible on the other face. This visibility is made possible by the low thickness of the support, which, depending on its grammage, may not be completely opaque. It will nevertheless be noted that the outlines of the shadow may appear imprecisely.

To make a paper-based support opaque with an additional barrier effect relative to the solvents (including water), it is known to use mineral fillers in the paper pulp and to add a fluorinated resin therein. This solution is not fully effective to obtain good opaqueness and a barrier effect against the solvents, even using large quantities of fluorinated resin. The use of the latter is generally reserved for papers specifically dedicated to wrapping oily products for the agri-food industry.

It is also possible to insert a layer of stratified adhesive between two paper plies, the adhesive optionally being able to contain opacifying agents. This principle is used by US 20130307257, which uses an intermediate joint made up of an adhesive and a grey dye. However, this solution has the drawback of modifying the color of the surface paper: the level of opaqueness of the latter not being sufficient to conceal the gray adhesive joint, the shade of the paper will therefore be darkened, and the latter will therefore be deemed less bright during the application of marker to that surface. Furthermore, when a light-colored marker is used, the solvent contained in the latter will locally make the sheet of paper transparent or translucent, and when the pigments reach the dark adhesive barrier, the marker line will take on a darker tint, which may be deemed unsightly by the user of the product. It is only when the solvent has dried that the marker line regains its original color, since the paper again becomes opaque enough to lighten the shade of the adhesive joint.

It is sometimes proposed to form a paper/solvent-tight film assembly, the assembly being formed using adhesive or using an intermediate extruded polymer connecting the two layers. The film is chosen for its opaqueness, and may be a film of polyethylene terephthalate or polypropylene for example containing chalk for opaqueness, or printed with an opacifying color on one face, or even an aluminum film But such an assembly is not usable as a double-sided support for graphic arts, since one of the faces is made up of a tight film

Thus, a double-sided support is lacking for graphic artists that is indeed opaque, with a high whiteness, resistant to solvent and pigments from a marker, including permanent marker, crossing through it, and retaining a moderate price.

### SUMMARY OF THE INVENTION

To resolve the aforementioned problems, proposed is a planar support with two faces for writing or drawing by hand consisting of an assembly of two fibrous thicknesses for affixing graphic marks on each of said two faces of the support, and a film inside said support, dark to make said support opaque, the film being adhered to each of the fibrous thicknesses by a respective joint for preparing thermoplastic material comprising light-colored fillers, for example but not necessarily mineral fillers, suitable, due to their concentration and the intensity of the shade that they give the thermoplastic material preparation, to conceal the inner film

In particular, the inner film is concealed from a viewer looking at the support using reflected light (diffuse reflection), even if the fiber thickness looked at by the viewer is made translucent by an imbibing liquid.

The product thus defined provides writing comfort for the user, is opaque and provides a barrier effect against the crossing of pigments or solids from one face to the other. The use of white fillers in the thermoplastic material ply also makes it possible not to darken a light-colored marker line, which will retain substantially the same color when wet during its application, and once dried on the surface of the paper.

For example, the film is a polyolefin film, such as a polyethylene or polypropylene, or polyester such as polyethylene terephthalate (PET), but may also have a base of polymers from renewable materials (biopolymers), such as polyhydroxyalkanoates, one example of which is polylactic acid (PLA).

In one embodiment, the film is opacified on the surface with an aluminum-based metallization.

Alternatively, the film bears ink printing to make it opaque, or the film comprises a pigment in its volume.

The film may have a thickness from 10 to 14 μm.

The film may have a grammage of the film between 15 and 19 g/m².

The film may also be an aluminum film with a thickness comprised between 2 and 12 μm, and preferably between 5 and 9 μm, with grammage between 5 and 30 g/m², for example between 12 and 25 g/m².

The preparation of the plastic material may comprise from 10 to 18 wt % of titanium dioxide.

The thermoplastic material preparation may have a base of polyolefin, or biopolymer.

The grammage of each of the thermoplastic material preparation joints may be comprised between 10 and 40 g/m².

The total grammage may be comprised between 180 and 250 g/m².

The film may have a thickness comprised between 5 and 50 μm.

At least one of the two fibrous thicknesses may be made from a fibrous material treated with a hydrophobic agent such as alkyl ketene dimer to adjust the level of hydrophobia of the surface of the paper.

Other alternatives are possible.

It is also proposed, in the context of the invention, to have a sheet cut to a format for manual graphic illustration, in a support as defined above, as well as a ream, a spiral notebook, a glued notebook, a notepad, a book or a book of such sheets.

The invention also relates to a method for manufacturing a planar support for writing or drawing by hand comprising extrusion of a thermoplastic polymer preparation in a fluid flow form between the first fibrous layer and a film to form a first assembly, then the cooling of the first assembly, and an extrusion of a thermoplastic polymer preparation in the form of a fluid flow between the film of the first assembly and a second fibrous layer to form a second assembly, the film being dark to make said support opaque, and the preparation of the plastic material comprising fillers, for example mineral fillers, that are white and that are suitable for concealing the inner film

Advantageously, the fibrous layers are each obtained by unwinding a paper spool.

The invention will now be described in relation to the figures.

### BRIEF DESCRIPTION OF DRAWING FIGURES

FIG. 1 is a diagram of one step of a manufacturing method according to the invention.

FIG. 2 is a view of an intermediate product, in section, obtained at the end of the step of FIG. 1.

FIG. 3 is a diagram of a second step of the manufacturing method according to the invention, beginning with the step of FIG. 1.

FIG. 4 is a view of a planar support according to one embodiment of the invention, obtained at the end of the step of FIG. 3.

FIG. 5 is a view of one usage mode of the support according to the invention.

FIG. 6 pertains to a presentation of the product, in one embodiment.

### DETAILED DESCRIPTION OF THE INVENTION

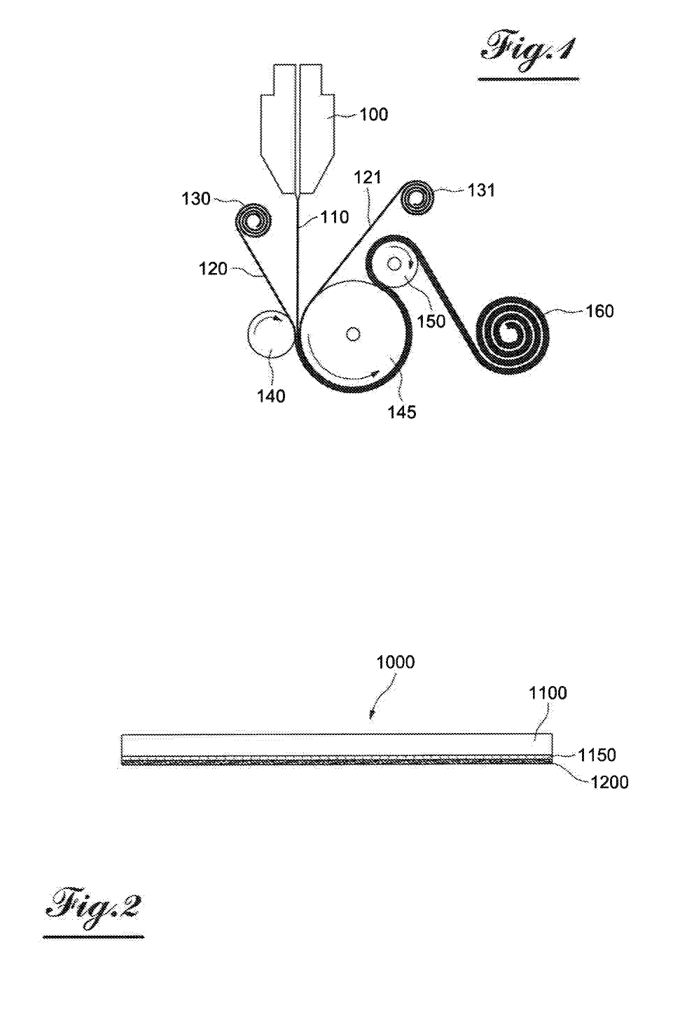

In reference to FIG. 1, which is a sectional view, an extruding machine 100 is used to deposit, through a channel, a molten polymer 110, in the form of a fluid flow, between a layer 120 of fibrous material that is for example unwound from an unwinder 130 bearing a paper spool and a layer 121 of polyethylene or other polyolefin film, for example unwound from an unwinder 131. The film can also be made with a base of polymers from renewable materials, or biopolymers, optionally bioplastics, such as polyhydroxyalkanoates, one example of which is polylactic acid (PLA). The film may also be an aluminum film, for example 7 μm thick.

The assembly made up of three layers is applied between two rollers 140 and 145, using pressure applied uniformly. A rolling of the three layers is then done.

The set of three layers, once assembled, is next driven on the surface of one of the rollers, here the roller 145, which is for example cooled on the surface, and which has a sufficient diameter for the time spent on that roller to allow the material to cool, so that the three layers are frozen together.

The assembly next optionally goes to an intermediate roller 150, before being wound on a winder to form a spool of intermediate product 160. Other equivalent assemblies are of course possible.

The flow rate of the extruding machine 100 and the speed of the unwinders 130 and 131 make it possible to adjust the quantities of material used.

In one embodiment, a single-ply paper at 75 g/m², or any other value between 50 and 100 g/m², and an aluminum-based metalized polyolefin film, 12 μm thick, or any value between 5 and 50 μm, and with a grammage of approximately 17 g/m², or between 12 and 22 g/m², are respectively provided on the unwinders 130 and 131. The film may also be a polyester film, such as polyethylene terephthalate (PET), or a film of another material such as a polyvinyl alcohol PVOH, an ethylene vinyl alcohol EVOH, or a biopolymer, such as a polyhydroxyalkanic acid or polyhydroxyalkanoate (PHA), for example a polylactic acid (PLA), or a poly-β-hydroxybutyrate (PHB). The film may be an aluminum film, for example 7 μm thick or with any thickness between 2 and 12 μm, for example, and with a grammage comprised between 5 and 30 g/m², or between 12 and 25 g/m², with a particular value of 19 g/m² in one example.

The spool of the unwinder 130 may also be a multi-ply paper spool, for example with two plies.

For the molten polymer 110, molten polyethylene is used, for example a low-density polyethylene melted at a temperature of approximately 300° C. obtained by extrusion, the deposition of which is comprised between 10 and 40 g/m². It is also possible to use molten polymers originating from renewable raw materials, such as PLA or polylactic acid, for example, or any polyhydroxyalkanic acid (PHA) appropriate for that purpose. The raw material is made up of 70 wt % of polyethylene granules filled with titanium dioxide of the anatase type, and 30 wt % of pure polyethylene, for a final titanium oxide content level of approximately 40 wt %, and more generally between 9 and 20% or between 12 and 18%. Other fillers or mixtures of fillers, mineral or non-mineral organic, may be used alternatively, or additionally.

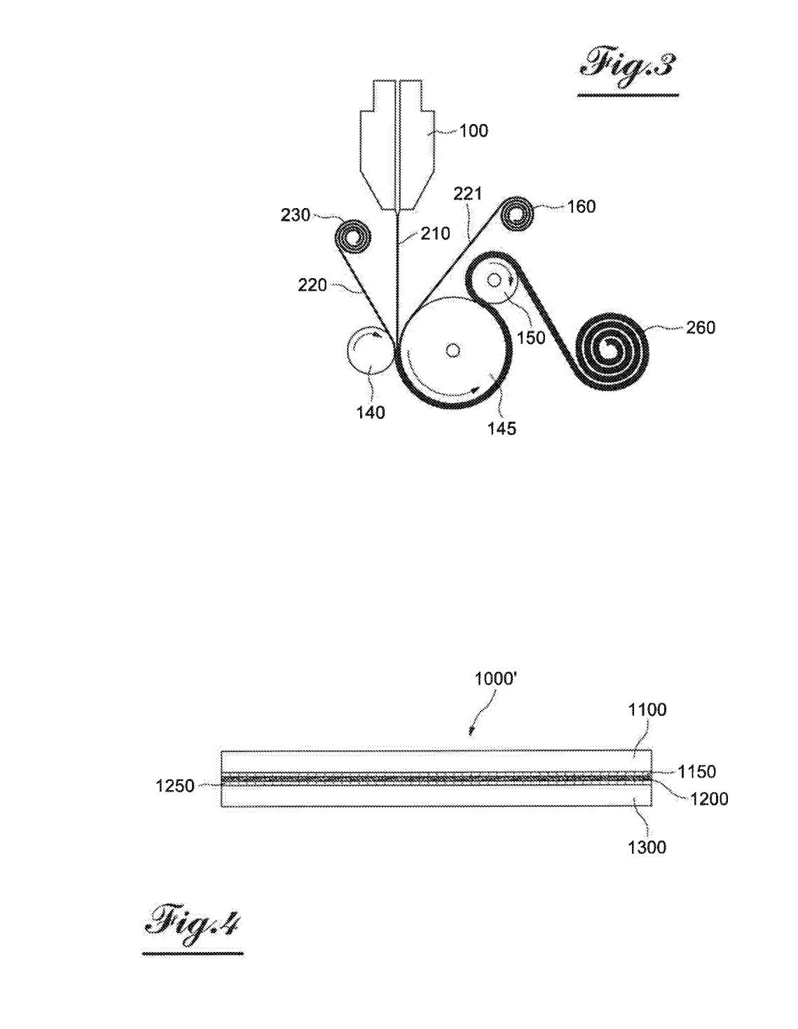

FIG. 2 shows the intermediate product obtained on the spool 160. It is made up of a layer 1100 of fibrous material allowing the affixing of graphic marks, and a layer 1200 of the opacified polymer film connected by a bleached extruded polymer joint 1150. The layer 1150 serves as adhesive between the paper and the film

In reference to FIG. 3, which is a sectional view similar to FIG. 1, an extruding machine 100, which may be the same as that used in FIG. 1 or another machine, is used to deposit, through a channel, a molten polymer 210, in the form of a fluid flow, between a layer 220 of fibrous material that is for example unwound from an unwinder 230 bearing a paper coil and a layer 221 of the intermediate product 1000 of FIG. 2, unwound from an unwinder 161 that may bear the coil 160 shown in FIG. 1. The molten polymer may be identical to that used in FIG. 1, or different.

The assembly is applied between two rollers 140 and 145, using a pressure applied uniformly. One thus performs a rolling of the layers, of which there are five in the case at hand, three of which have been rolled together beforehand

The set of five layers, once thus assembled, is next driven on the surface of one of the rollers, here the roller 145, which is for example cooled on the surface, and which again has a sufficient diameter for the time spent on this roller to allow the material to cool, so that the five layers are frozen together.

The assembly next optionally goes onto an intermediate roller 150, before being wound on a winder to form a spool of final product 260.

Other equivalent assemblies are of course possible.

The flow rate of the extruding machine 100 and the speed of the unwinders 230 and 161 make it possible, as before, to adjust the quantities of materials used.

In one example embodiment, a single-ply paper at 75 g/m², or any value between 50 and 100 g/m², and the intermediate product 1000, respectively, are provided on the unwinders 230 and 161. The spool of the unwinder 230 may thus be a multi-ply paper spool, for example with two plies.

As an example, for the molten polymer 210, molten polyethylene is again used obtained by extrusion, deposited at a rate having a value comprised between 10 and 40 g/m². The raw material is again made up of 70 wt % of polyethylene granules filled with titanium dioxide of the anatase type, and 30 wt % of pure polyethylene, for a final content level of titanium dioxide of approximately 14 wt %, and more generally between 9 and 20% or between 12 and 18%. As before, other fillers or mixtures of fillers, mineral or non-mineral, may be used alternatively or additionally.

Ultimately, a product is obtained that may be symmetrical, advantageously.

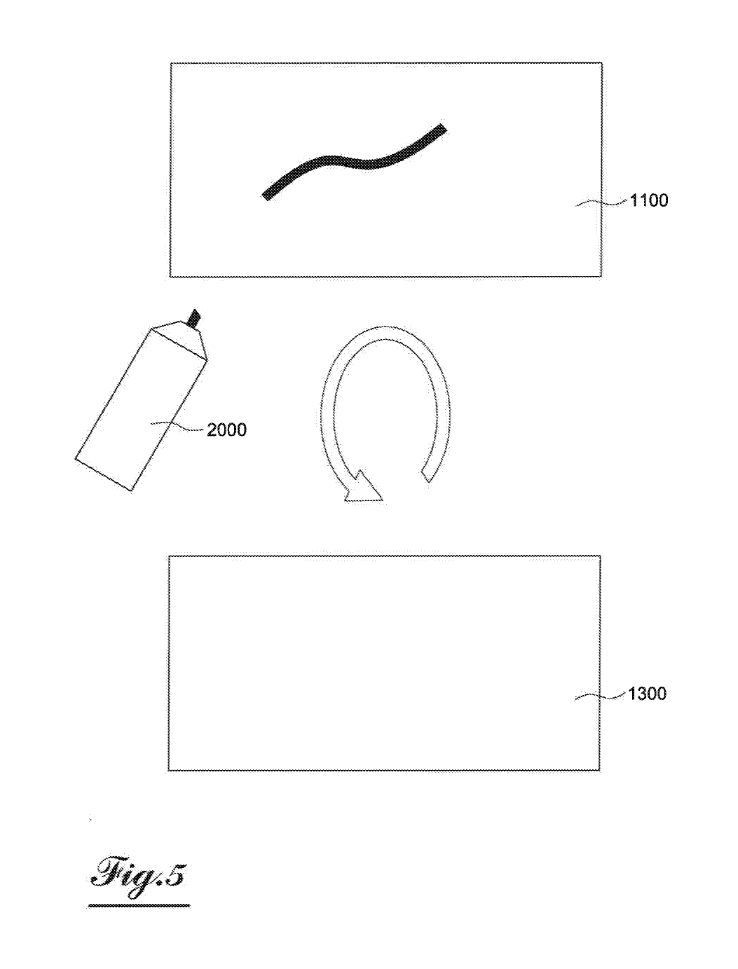

FIG. 4 shows the final product 1000′ obtained on the spool 260. It is made up of a layer 1100 of fibrous material allowing the affixing of graphic marks, a layer 1200 of opacified polymer film and a layer 1300 of fibrous material allowing the affixing of graphic marks, connected by extruded polymer joints 1150 and 1250 that are bleached, acting as adhesive.

The layers of fibrous material may be layers of paper treated with a hydrophobic material, to receive the solvent-based marker pigments. Preferably, a paper with a small thickness (50 to 100 g/m²) is chosen, allowing easy use for writing, in particular with solvent-based markers of the comic strip or manga type. The paper is chosen to have a smooth surface with good whiteness. The hydrophobia (or adhesion) is chosen to allow the artist to deposit lines, the absorption and any color mixing of which may be controlled. The adhesion level is provided by the prior addition, in the paper pulp, of hydrophobic products such as alkyl ketene dimer (AKP) in a maximum dose of 0.4%, pure, relative to the fibrous mass.

The product may have a grammage of 250 g/m². Its rigidity may be adapted based on the quality of extruded polymer used as well as the thickness of the metalized film.

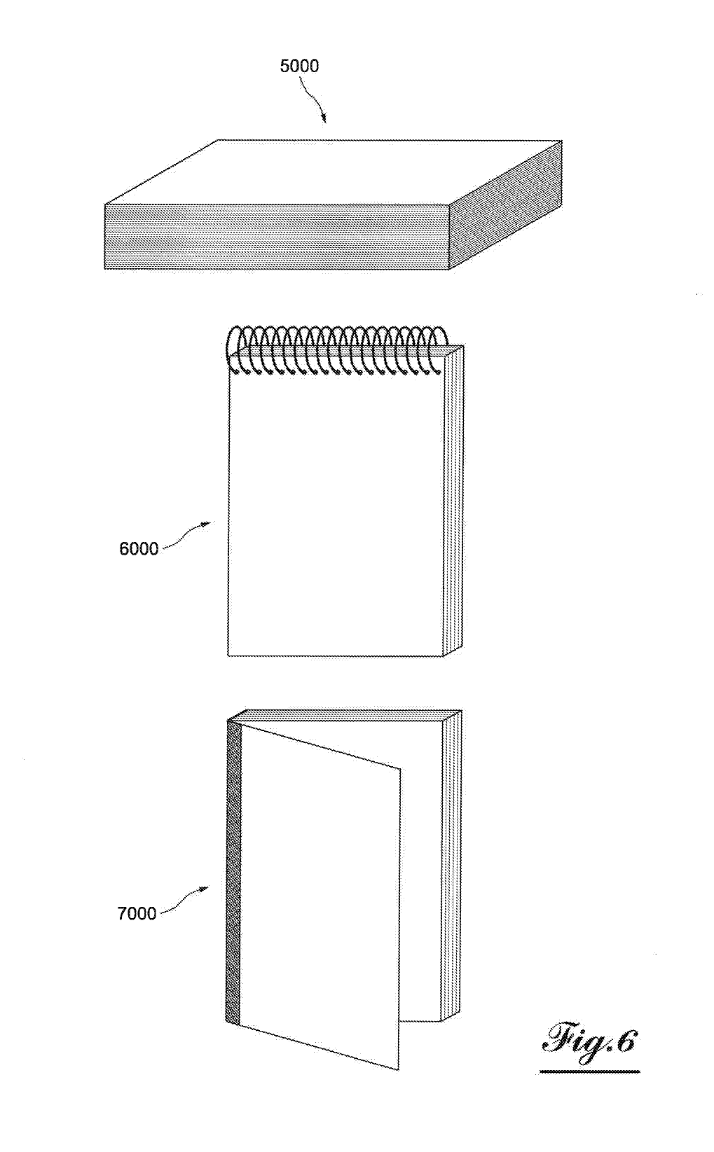

FIG. 5 shows the use of the support. It may be used for graphic art on its first face 1100, using a marker 2000, which may be a water- or solvent-based marker. It is also possible to use paint, Indian ink, pen, pencil, charcoal or pastels, as well as watercolors or poster paint. The graphic marks are fixed by the fibrous material, in a solid and persistent manner Upon turning over the sheet, the graphic marks borne by the face 1100 remain invisible on the face 1200. Indeed, the light with indirect transmission is blocked by the film 1200 (FIG. 4), and there is also no light diffusion by this film 1200. The shadow of the graphic marks does not appear on the face 1300.

Furthermore, owing to the presence of light-colored fillers in the extruded polymer joints 1150 and 1250 (FIG. 4), the dark appearance of the metalized film 1200 is prevented from being visible when, by application of a solvent-based marker, the paper is temporarily made translucent by the presence, in its volume, of the solvent, making the lower layer visible to the viewer looking at the light globally reflected (diffuse reflection) by the support, until evaporation of the solvent. The extruded polymer joint 1150 or 1250 thus conceals the film 1200.

It will be noted that the metalized film may have, in addition to its dark color, also a low brilliance, since it cannot re-emit the reflected light below the molten polymer joint. It is therefore particularly useful to conceal it using fillers introduced in the molten polymer.

It is also specified that the whiteness of the background of the paper guarantees the performance and contrast of the lines applied to the surface of the paper. In the aforementioned example, the composition of the different elements of the complex makes it possible to achieve a CIE (International Commission on Illumination) whiteness of approximately 145, which allows a good contrast with the graphic elements deposited on the surface of the paper during the artistic application.

FIG. 6 shows a ream 5000 of paper comprising sheets separated from one another, stacked. Each sheet is made up of a planar support 1000 as shown in FIG. 2.

A notebook 6000 of sheets is also shown connected by a spiral notebook making up the binding, the sheets for example being individually detachable from the binding. In place of the spiral, straight turns parallel to one another (integral binding or Wire-O) can be used.

A book is also shown with a hard cover, here a book with a padded cover and sewn sheets 7000, the pages of which are made up of the planar support according to the invention.

The invention is not limited to the described embodiment, but extends to all alternatives within the scope of the claims.

1. A planar support with two faces which may be written or drawn on, by hand, the planar support consisting of:
two fibrous layers having respective thicknesses that provide the two faces of the planar support,
a film inside the planar support and making the support opaque, wherein the film is adhered to each of the two fibrous layers, and
respective thermoplastic material layers joining the two fibrous layers to the film and comprising light-colored fillers concealing the film.

2. The planar support according to claim 1, wherein the film is one of a polyolefin, polyester and a biopolymer film.

3. The planar support according to claim 1, wherein the film includes, on a surface, one of an aluminum-based metallization, and ink printing.

4. The planar support according to claim 1, wherein the film comprises a pigment.

5. The planar support according to claim 1, wherein the film is an aluminum film.

6. The planar support according to claim 5, wherein the film has a thickness in a range from 2 μm to 12 μm.

7. The planar support according to claim 5, wherein the film has a weight per unit area in a range from 5 g/m² to 30 g/m².

8. The planar support according to claim 1, wherein the film has a thickness in a range from 5 μm to 50 μm.

9. The planar support according to claim 1, wherein the film has a weight per unit area is in a range from 15 g/m² to 19 g/m².

10. The planar support according to claim 1, wherein the thermoplastic material layers comprise from 10 wt % to 18 wt % of titanium dioxide.

11. The planar support according to claim 1, wherein weight per unit area of the thermoplastic material layers is in a range from 10 g/m² and 40 g/m².

12. The planar support according to claim 1, wherein the thermoplastic material layers include a base of polyolefin or biopolymer.

13. The planar support according to claim 1 having a total weight per unit area in a range from 180 g/m² to 250 g/m².

14. The planar support according to claim 1, wherein at least one of the two fibrous layers has been treated with a hydrophobic agent.

15. A sheet cut to a format for manual graphic illustration, in a planar support according to claim 1.

16. (canceled)

17. A method for manufacturing a planar support with two faces for writing or drawing on the two faces, by hand, the method comprising:
preparing a thermoplastic polymer preparation comprising light colored fillers,
extruding the thermoplastic polymer preparation, in a fluid flow form, between a first fibrous layer and a film to form a first assembly,
cooling the first assembly, and
extrusion of extruding the thermoplastic polymer preparation in a fluid flow form between the film of the first assembly and a second fibrous layer to form a second assembly, wherein the film makes the support opaque.

18. The manufacturing method according to claim 17, wherein the fibrous layers are respectively provided by unwinding paper spools.
